(19) United States
(12) Patent Application Publication
(10) Pub. No.: US 2004/0049771 A1
(43) Pub. Date: Mar. 11, 2004

(54) Home network apparatus, method and controlling home network and system using the same

(76) Inventor: Won-Uk Yu, Daegu (KR)

Correspondence Address: JACOBSON HOLMAN PLLC, 400 SEVENTH STREET N.W., SUITE 600, WASHINGTON, DC, 20004, US

(21) Appl. No.: 10/648,239

(22) Filed: Aug. 27, 2003

(30) Foreign Application Priority Data
Aug. 31, 2002 (KR) 10-2002-0052236

(51) Int. Cl. G09G 5/00; G06F 9/44

(52) U.S. Cl. 717/172; 345/809

(57) ABSTRACT

A home network control system and method, which can control equipments of the home network more simply and conveniently by downloading control programs using the Internet. If a new control menu exists in a server, the new control menu and corresponding programs are downloaded through the Internet. At this point, the downloaded control menu is registered as a new control menu list into an old control menu list, and the control programs are provided to the corresponding equipments and stored therein. A user executes the corresponding programs using the new control menu item such that the corresponding equipments are controlled more conveniently.

### BACKGROUND OF THE INVENTION

1. Field of the Invention

The present invention relates to a home network apparatus, and more particularly to a system for controlling a home network and a method thereof, in which equipment connected to the home network is controlled simply and conveniently by downloading corresponding control programs.

2. Description of the Related Art

Recently, with the advance of communication technologies, home network systems have been steadily developed which can control home audiovisual equipment such as a TV, DVD player and VCR, and household appliances such as cooking appliances, refrigerator and washing machine, as well as information communication equipment such as a personal computer, fax, printer, etc., by connecting them via a network. In other words, the home network system can control all the home digital electronic devices through a connection to the network established in the home via either a distributed computer network such as the Internet or a telephone line at an exterior as well as in the home.

However, since a conventional home network system does not provide all the control programs necessary for controlling the respective equipments, there is a limit to how many of the respective equipments can be controlled.

In addition, even if the home network system has all the control programs, upgraded versions of the control programs are not provided, which undermines the homeowner's confidence in the home network that is being developed.

Even if a new control program or an upgraded control program is developed, it can be difficult for the user to individually purchase and install the control programs correctly so as to be able to use them.

Accordingly, there is a need for a system and a method for simply controlling the equipment on a home network, which can also conveniently download new control programs or updated control programs at home.

### SUMMARY OF THE INVENTION

Accordingly, the present invention is directed to a system and a method for controlling a home network system that substantially obviates one or more problems due to limitations and disadvantages of the related art.

It is an object of the present invention to provide a system and a method for controlling a home network more conveniently by downloading, through the Internet, the control programs used to control respective equipments.

It is another object of the present invention to provide a system and a method in which the user's convenience is maximally improved without regard to location. According to the system and method, control programs for other equipments are downloaded at any time using one equipment and thereafter provided to corresponding equipments.

To attain the above objects and other advantages, in accordance with a first embodiment of the present invention there is provided a method for controlling a home network, which comprises the steps of ascertaining whether or not a new control menu exists by using the Internet; if the new control menu exists, downloading the new control menu and adding the downloaded new control menu to an old control menu list; and downloading corresponding control programs using the added new control menu.

In accordance with a second embodiment of the present invention, there is provided a method for controlling a home network, which comprises the steps of ascertaining whether or not a new control menu exists by using the Internet; and if the new control menu exists, downloading the new control menu and a corresponding control program.

In accordance with a third embodiment of the present invention, there is provided a method for controlling a home network which comprises the steps of a) ascertaining whether or not new control menus for equipments exist by using the Internet; b) if the new control menus for the equipments exist, downloading the new control menus and adding the downloaded new control menus to old control menu lists according to the equipments; c) downloading corresponding programs using the added new control menus; and d) providing the downloaded new control menus to the corresponding equipments.

In accordance with a fourth embodiment of the present invention, there is provided a method for controlling a home network which comprises the steps of a) ascertaining whether or not new control menus for equipments exist by using the Internet; b) if the new control menus for the equipments exist, downloading the new control menus and corresponding control programs; and c) providing the downloaded control programs to the corresponding equipments.

In accordance with a fifth embodiment of the present invention, there is provided a system for controlling a home network including means for ascertaining whether or not a new control menu exists by using the Internet; means for downloading the new control menu and adding the downloaded new control menu to an old control menu list, in case the new control menu exists; and means for downloading corresponding control programs using the added new control menu.

In accordance with a sixth embodiment of the present invention, there is provided a system for controlling a home network including means for ascertaining whether or not a new control menu exists by using the Internet; and means for downloading the new control menu and a corresponding control program, in case the new control menu exists.

In accordance with a seventh embodiment of the present invention, there is provided a system for controlling a home network including first means for ascertaining whether or not new control menus for equipments exist by using the Internet; second means for downloading the new control menus and adding the downloaded new control menus to old control menu lists according to the equipments, in case the new control menus for the equipments exist; third means for downloading corresponding programs using the added new control menus; and fourth means for providing the downloaded new control menus to the corresponding equipments.

In accordance with a eighth embodiment of the present invention, there is provided a system for controlling a home network including first means for ascertaining whether or not new control menus for equipments exist by using the Internet; second means for downloading the new control menus and corresponding control programs, in case the new control menus for the equipments exist; and third means for providing the downloaded control programs to the corresponding equipments.

In accordance with a tenth embodiment of the present invention, there is provided a home network apparatus which includes an Internet network and a home network that receives information through the Internet network. The home network apparatus comprises a power line for supplying communication signals, control signals and power source; and a plurality of equipments connected to the power line and having an Internet function and an on-screen function. The equipments download control menus and corresponding control programs from the Internet network by using the Internet function, and control menu lists with the control menus are displayed on screen by using the on-screen function. The apparatus further includes a menu manager for storing the control menu lists, registering the downloaded control menu as a new control menu item into the control menu list, and providing the control menu lists to the respective equipments by request, wherein the plurality of equipments download the control programs for other equipments as well as their own control programs through the Internet network.

It is to be understood that both the foregoing general description and the following detailed description of the present invention are exemplary and explanatory and are intended to provide further explanation of the present invention as claimed.

### BRIEF DESCRIPTION OF THE DRAWINGS

The accompanying drawings, which are included to provide a further understanding of the present invention and are incorporated in and constitute a part of this application, illustrate embodiment(s) of the present invention and, together with the description, serve to explain the principles of the present invention. In the drawings:

FIG. 1 is a block diagram schematically showing the construction of a home network apparatus capable of controlling resident equipment according to an embodiment of the present invention;

FIG. 2 is an overall flowchart showing a method for controlling a home network in the home network apparatus according to an embodiment of the present invention, in which a user directly controls the home network;

FIG. 3 is a flowchart showing a method for updating the download control menu of FIG. 2;

FIG. 4 is a flowchart showing a method for downloading control programs using the updated download control menu of FIG. 2;

FIG. 5 is a flowchart showing a method for controlling the home network in the home network apparatus according to an embodiment of the present invention, in which the equipments themselves control the home network;

FIGS. 6A and 6B are exemplary views of the control menu screen according to an embodiment of the present invention;

FIG. 7 is a block diagram schematically showing the construction of a home network apparatus that can control a plurality of equipments, according to another embodiment of the present invention;

FIG. 8 is a flowchart showing a method for updating a download control menu for equipments in the home network apparatus, according to another embodiment of the present invention;

FIG. 9 is a flowchart for downloading control programs using the updated control menu in the home network apparatus in accordance with a preferred another embodiment of the present invention;

FIG. 10 is a flowchart showing a method for controlling a home network in the home network apparatus according to another embodiment of the present invention, in which the equipments themselves control the home network; and

FIGS. 11A and 11B are exemplary views of the control menu screen according to another embodiment of the present invention.

### DETAILED DESCRIPTION OF THE PREFERRED EMBODIMENTS

Reference will now be made in detail to a preferred embodiment of the present invention with reference to the attached drawings. The same reference numerals and symbols denote common elements performing the same functions.

A description of the present invention will be made in two parts. The first is directed to a method for downloading control programs used to control only corresponding equipments, and the second addresses another method for downloading control programs used to control a plurality of other equipments. In both descriptions, where references to “the Internet” are made, it is to be understood that any appropriate distributed computer network may be used and that the present invention is not limited to use with only the Internet.

Embodiment 1: Method for Downloading Control Programs used to Control only Corresponding Equipments.

Prior to a description of the first method, a home network apparatus for implementing the first method will be described below.

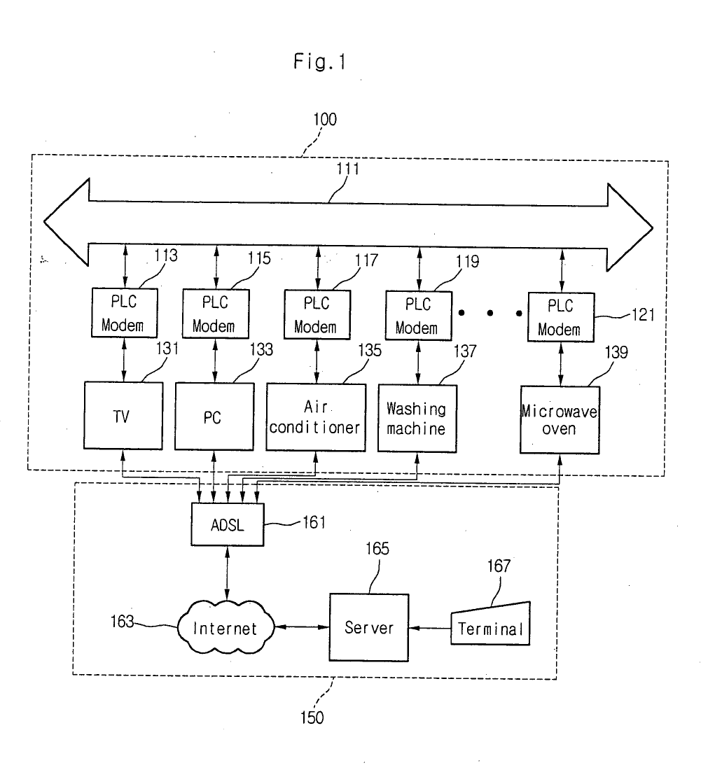

FIG. 1 is a block diagram schematically showing the construction of a home network apparatus capable of controlling its own equipments according to a preferred embodiment of the present invention.

As shown in FIG. 1, the home network apparatus of the present invention includes a home network 100 for downloading control programs capable of controlling corresponding equipments via the Internet, and an Internet network 150 having the control programs corresponding to the request of the home network 100.

In more detail, the home network includes a power line 111 for supplying communication signals, control signals and power source; a plurality of power line modems 113 to 121 connected to the power line 111 to interface the communication and control signals between such line and equipments connected to the modems; and a plurality of equipments connected to the corresponding power line modems 113 to 121, in which the equipments representatively include a television set 131, a personal computer 133, an air conditioner 135, a washing machine 137, and a microwave oven 139; other equipment could, of course, be similarly connected.

The plurality of equipments 131 to 139 should have basically an on-screen function and an Internet function. A user can control the respective equipments through screens displayed by the on-screen function, and download desired control programs by connecting the respective equipments to the Internet network using the Internet function. It should be noted that the present invention is applicable to any equipments having the on-screen function and the Internet function, not just to the above equipments 131 to 139.

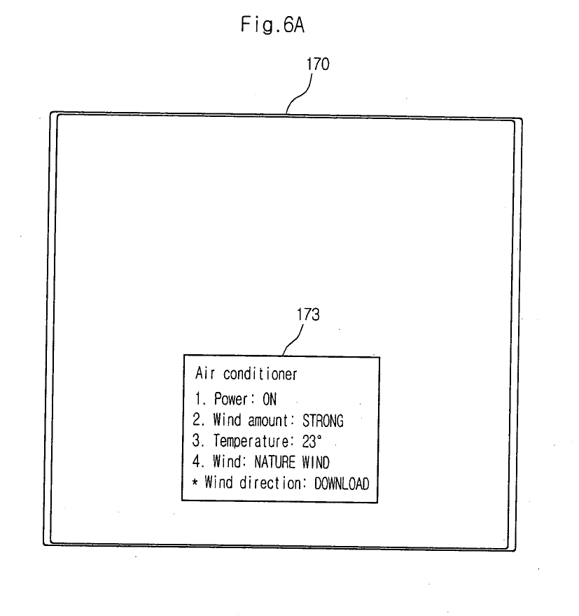

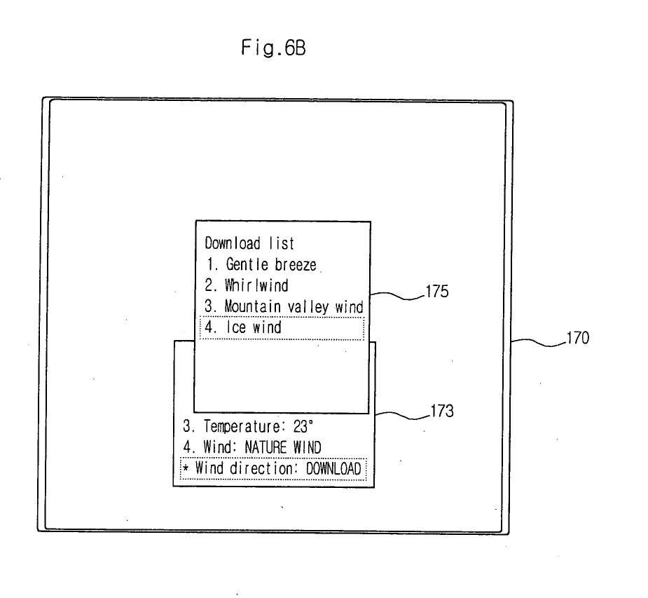

In this embodiment, the equipments 131 and 139 can download only their own control programs, and control menus used to download the control programs are provided separately according to the equipments. For example, as shown in FIG. 6A, the air conditioner item contains only its own control menu.

The Internet network 150 includes an ADSL 161 for connecting the equipments 131 to 139 to the Internet to interface the communication and control signals; Internet 163 connected to a server 165 along corresponding paths using the ADSL 161, the server 165 having control programs to be provided to the equipments 131 to 139 based on the Internet 163; and a terminal 167 for inputting the control programs to the server 165.

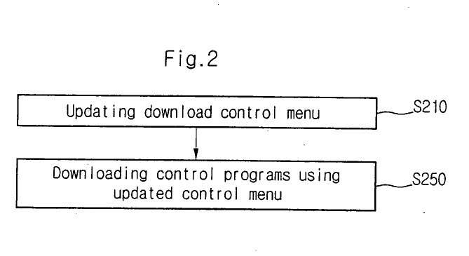

A method for controlling the home network in the home network apparatus constructed as above will be described below with reference to FIGS. 2 to 4.

As described above, the home network apparatus includes a plurality of equipments connected to the power line. In the present invention, although a television set among these equipments will be described as an example, the other equipments can also perform the same operations shown in FIGS. 2 to 4.

FIG. 2 is an overall flowchart showing a method for controlling the home network in the home network apparatus according to an embodiment of the present invention.

Referring to FIG. 2, the method of the present invention includes the step S210 of updating a download control menu and the step S250 of downloading control programs using the updated control menu. Here, the step S210 relates to a method for downloading the control menu from the server so as to allow a user to download corresponding control programs, and the step S250 relates to a method of downloading corresponding programs using the control menu updated by the user.

Of course, even though the user can download the control programs by controlling the corresponding equipments, the corresponding equipments themselves can also automatically download the control programs without any involvement by the user, which will be described later.

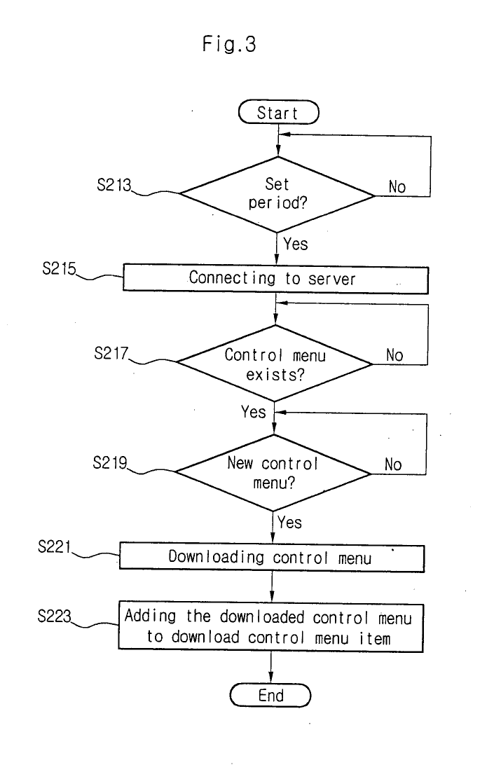

First, the step S210 of updating the download control menu will be described with reference to FIG. 3, which is a flowchart showing the method for updating the download control menu shown in FIG. 2.

Referring to FIG. 3, a set period is checked, step S213. The television set is periodically connected to the server and checks whether or not the control program exists in the server. Here, the period can be set to a particular hour each day, every hour, three times per week, or any other desired interval.

If it is determined that the set period has been reached, the television set is connected to the server through the Internet, step S215. The television set, once connected to the server, ascertains whether or not there is a control menu in the server, step S217. Here, the control menu is a menu used to download the control programs and can include control submenus. In FIG. 6B, for example, a “download list” can be the control menu, and “gentle breeze, whirlwind, mountain valley wind, ice wind” can be the control submenus.

In case there is a control menu in the server, the television set ascertains at step 219 whether or not the control menu is a new control menu by comparing it with an existing control menu list. For example, in FIG. 6A, the control menu list includes power, wind amount, temperature and wind. To make this comparison, the television set downloads the control menu from the server, step 221, and compares its own current control menu list with the downloaded control menu. Through the comparison, the television can know whether or not the control menu is new. Additionally, although the downloaded control menu may exist in the old control menu list, the control menu will be considered as a new control menu if it is an upgraded version. In FIG. 6B, for example, in case a nature wind exists in both the old control menu list and the server, if a version of the nature wind existing in the server is higher than that existing in the old control menu list, the nature wind existing in the server will be considered as a new control menu.

As a result of this comparison, if the control menu existing in the server is a new control menu, the control menu is added to the download control menu item, step S223.

For example, as shown in FIG. 6B, the control menu item is added as an item “Wind Direction Download”. The addition of the download control menu item can be expressed as a generation of the control menu item. Here, it is important that the control menu downloaded from the server be added to the old control menu list (in FIG. 6A, a power item, a wind amount item, a temperature item and a wind item) as control menu items that can allow the user to select them so as to download the corresponding program using the control menu.

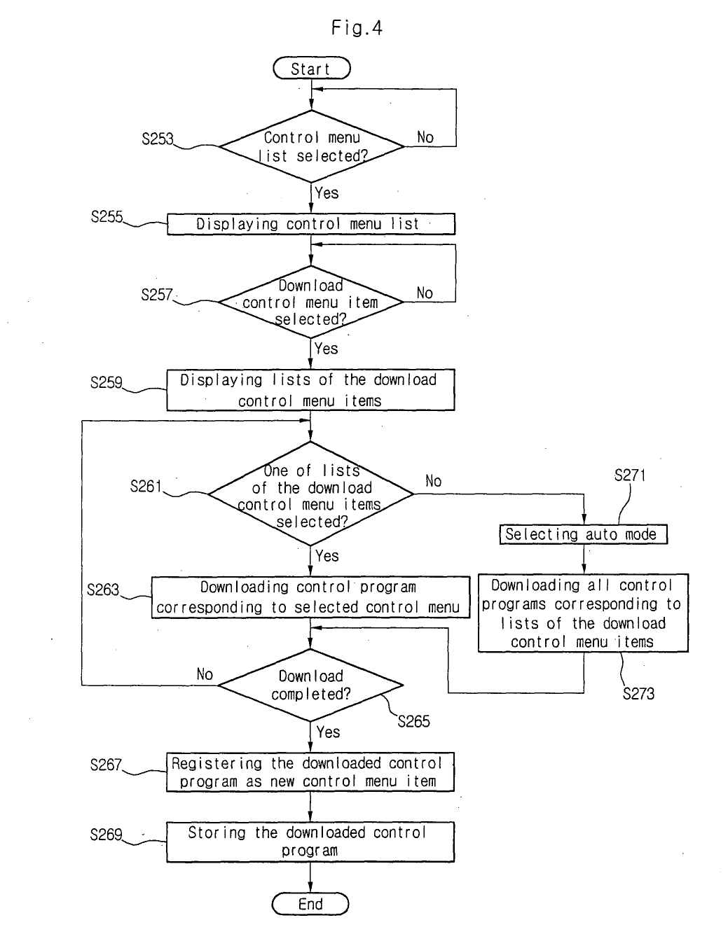

In this way, if the download control menu is added to the old control menu list, the user can download the corresponding control program using the download control menu items, which will be described with reference to FIG. 4.

FIG. 4 is a flowchart showing a method for downloading the control programs using the updated control menu of FIG. 2.

Referring to FIG. 4, the user displays the control menu list so as to download the control programs. In other words, if the user selects the control menu list through a key manipulation using an input device such as a remote controller, step S253, the television set recognizes it and displays the corresponding control menu list on an on-screen display (OSD), step S255 as shown in FIG. 6A. In FIG. 6A, an air conditioner control menu list 173 is displayed on the control menu screen 170. The control menu list includes a plurality of control menu items such as a power item, a wind amount item, a temperature item, a wind item and a wind direction download item. Here, the power item, the wind amount item, the temperature item and the wind item are the old control menu list, and the wind direction download item is the download control menu item for downloading the control programs.

If the user selects the download control menu item among the displayed control menu list, step S257, the television set displays lists of the selected download control menu items, step 259. This is shown representatively by 175 in FIG. 6B, including the control submenus for a gentle breeze, a whirlwind, a mountain valley wind, and an ice wind.

At this point, if the user selects one of the control submenus, step S261, e.g, the ice wind of FIG. 6B, the control program corresponding to the selected submenu is downloaded from the server, step S263.

The user can download all control programs corresponding to the control submenus, or only a specific control program.

In addition, instead of downloading the corresponding control programs in response to the user's individual selection of the control menu, the equipments themselves can download the control programs by setting up an auto mode, step S271. If necessary, the auto mode item can be provided in the old control menu list. By doing so, the equipments themselves download the control programs when the user selects the auto mode.

If the user selects the auto mode, the television set downloads from the server all control programs corresponding to the respective control submenus that contain the download control menu item list, step S273.

Meanwhile, if the download operation is completed, step S265, the control menu for the downloaded control programs is registered in the old control menu list as a new control menu item, step S267. Then, the downloaded control program is stored in the television set, step S269. Of course, the downloaded control programs can be installed and maintained in an execution-ready state. Here, the “downloaded control programs” means a control program for controlling the equipment itself, i.e., the television set, according to the first embodiment of the present invention. However, if an equipment can download control programs for other equipments, the equipment should further perform an operation of providing the downloaded programs to corresponding equipments, which will be described in the second embodiment of the present invention.

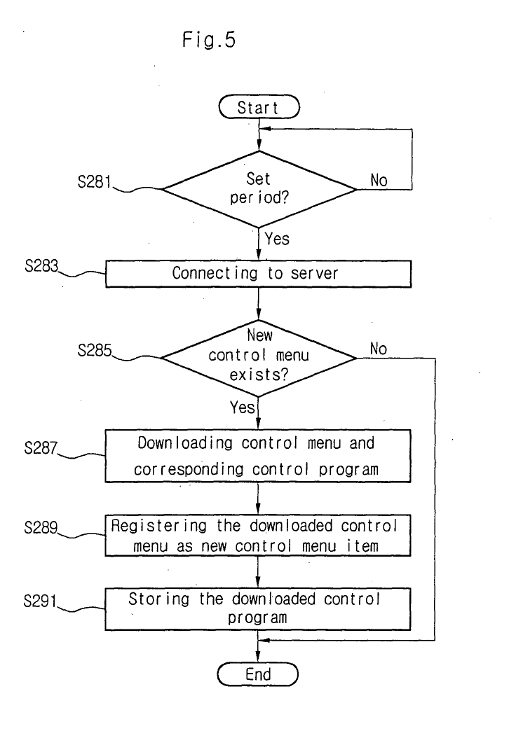

The equipments, as described above, can automatically download corresponding control programs without any involvement of the user, which will be described with reference to FIG. 5.

FIG. 5 is a flowchart showing a method for controlling a home network in the home network apparatus according to an embodiment of the present invention, in which the equipments themselves control the home network.

Referring to FIG. 5, first, a set period is checked, step S281. Here, the period can be set to a particular hour each day, every hour, three times per week, or any other desired interval.

If it is determined that the set period has been reached, the television set is connected to the server through the Internet, step S283.

Then, the television set ascertains whether or not a new control menu exists in the server, step S285. In other words, an old control menu list contained in the television set is transmitted to the server and compared with the control menu existing in the server. Alternatively, the control menu existing in the server is loaded into the television set and compared with the old control menu list. In so doing, it is possible to check whether or not a new control menu exists in the server. Meanwhile, although the control menu contained in the old control menu list of the television set exists in the server, the control menu existing in the server will be considered as a new control menu if the control menu existing in the server is an upgraded version.

If it is determined in the step S285 that a new control menu exists in the server, the control menu existing in the server and the corresponding control program are downloaded, step S287.

At this point, while the downloaded new control menu is registered in the old control menu list as a new registered control item, step S289, the downloaded control program is stored into the television set, step S291.

As described above, without any involvement of the user, the equipments themselves may be set to periodically connect to the server and download the control menus and the corresponding control programs at any set time.

Hereinafter, there will be described a method for downloading control programs for equipments using one equipment according to another embodiment of the present invention.

Embodiments 2: Methods for Downloading Control Programs used to Control Equipments Different from Each Other.

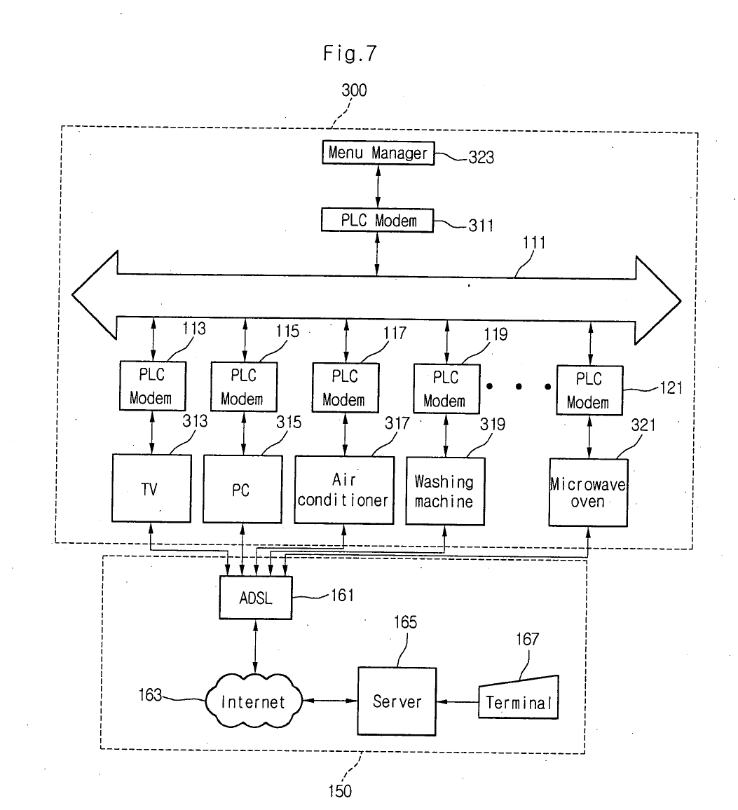

FIG. 7 is a block diagram schematically showing the construction of a home network apparatus that can control a plurality of equipments according to another embodiment of the present invention.

A home network control system for downloading the control programs that control a plurality of equipments using one equipment has the same structure as that of FIG. 1. However, compared with the home network apparatus of FIG. 1, the home network control system of FIG. 7 further includes a menu manager 323 that makes it possible to share the control menu list. Additionally, a power line modem 311 for connecting the menu manager 323 with the equipments 313 to 321 is provided.

Describing in detail with reference to FIG. 7, the home network apparatus of the present invention includes a home network for downloading control programs capable of controlling corresponding equipments via the Internet, and an Internet network having the control programs corresponding to the request of the home network.

The home network includes a power line 111 for supplying communication signals, control signals and power source; a plurality of power line modems 113 to 121 and 131 connected to the power line 111 to interface the communication and control signals between such line and equipments connected to the modems; and a plurality of equipments connected to the corresponding power line modems 113 to 121, in which the equipments representatively include a television set 313, a personal computer 315, an air conditioner 317, a washing machine 319, and a microwave oven 321; other equipment could, of course, be similarly connected. In addition, the network includes a menu manager 323 for storing and managing the control menu list so as to make it possible to display the control menu list of other equipments on a display of the corresponding equipment even if the user controls the home network using still other equipment. Here, the menu manager allows the respective equipments to share the control menu lists of all equipments connected to the home network.

The plurality of equipments 313 to 321 should basically have an on-screen function and an Internet function. Additionally, it is desired that the equipments be operated to also download the control programs for other equipments and control the corresponding equipments. The user can control the respective equipments through screens displayed by the on-screen function, and download desired control programs by connecting the respective equipments to the Internet network using the Internet function. It should be noted that the present invention is applicable to any equipments having the on-screen function and the Internet function, and is not limited to the above equipments 313 to 321.

The Internet network 150 includes an ADSL 161 for connecting the equipments 313 to 321 to the Internet to interface communication and control signals; the Internet 163 connected to an external server along corresponding paths by using the ADSL 161; a server 165 having control programs to be provided to the equipments 313 to 321 based on the Internet 163; and a terminal 167 for providing the control programs to the server 165.

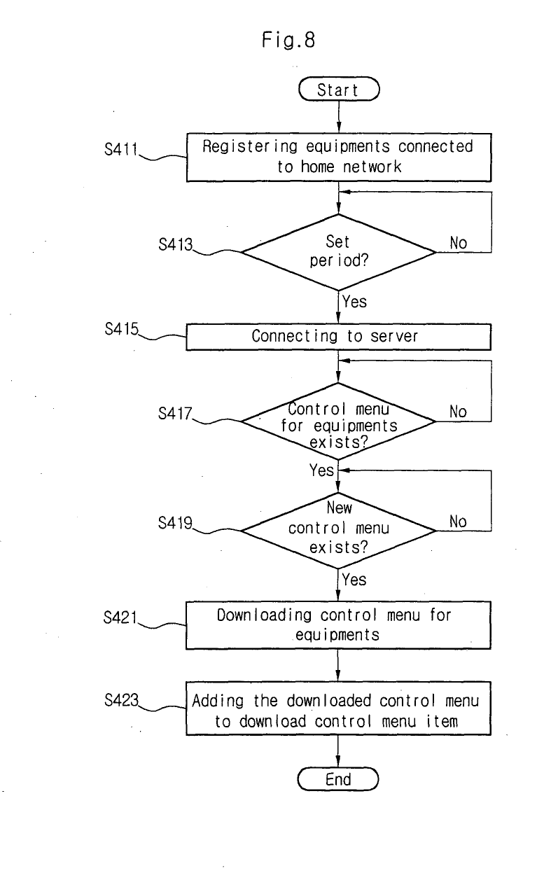

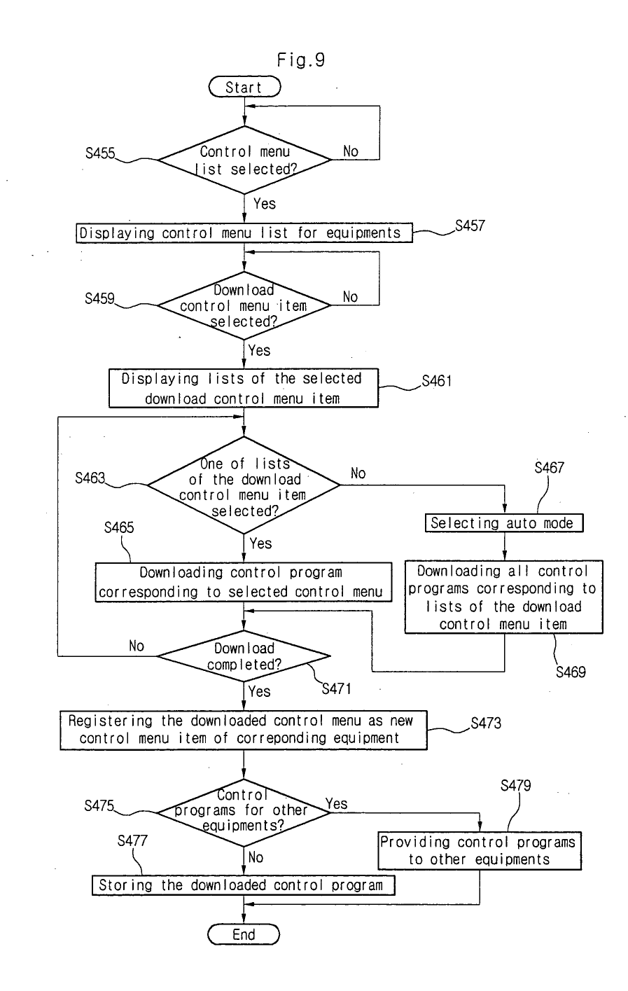

A method for controlling the home network of the home network apparatus constructed as above will be described below with reference to FIGS. 8 and 9.

The method of FIGS. 8 and 9 is basically similar to the method of FIG. 2. However, in the method according to the second embodiment of the present invention, the control menus are updated according to the respective equipments, and corresponding control programs are downloaded using the updated control menus and provided to corresponding equipments.

Although a television set will be described as an example in the home network control method of the present invention, it is noted that the other equipments can also perform the same operation as the television set.

FIG. 8 is a flowchart showing a method for updating control menus for respective equipments according to the second embodiment of the present invention.

Referring to FIG. 8, first, the equipments connected to the home network are registered, step S411. At this point, the respective equipments can be separately registered, or the respective equipments can be collectively registered into the menu manger and provided with the control programs.

The television set checks a set period, step S413, and is connected to the server via the Internet at the set period, step S415.

Control programs for the respective equipments can be stored in the server in advance together with the control menus. Of course, if there are no new control programs, the control programs may not be stored.

The television set ascertains whether or not the control menus for the equipments exist in the server, step S417. If the control menus for the equipments exist in the server, the television set checks whether or not the control menus are new control menus by comparing them with the old control menu list, step S419. In response to the comparison result, if new control menus exist in the server, corresponding control menus are downloaded, step S421.

The downloaded control menus are added to a download control menu item, step S423. In other words, the television set transmits the downloaded control menus to the menu manager, and the menu manager adds the downloaded control menus to the download control menu item.

A method for directly downloading the corresponding control programs by using the added control menus will be described with reference to FIG. 9.

FIG. 9 is a flowchart for downloading the control programs using the updated control menus for the equipments according to another embodiment of the present invention.

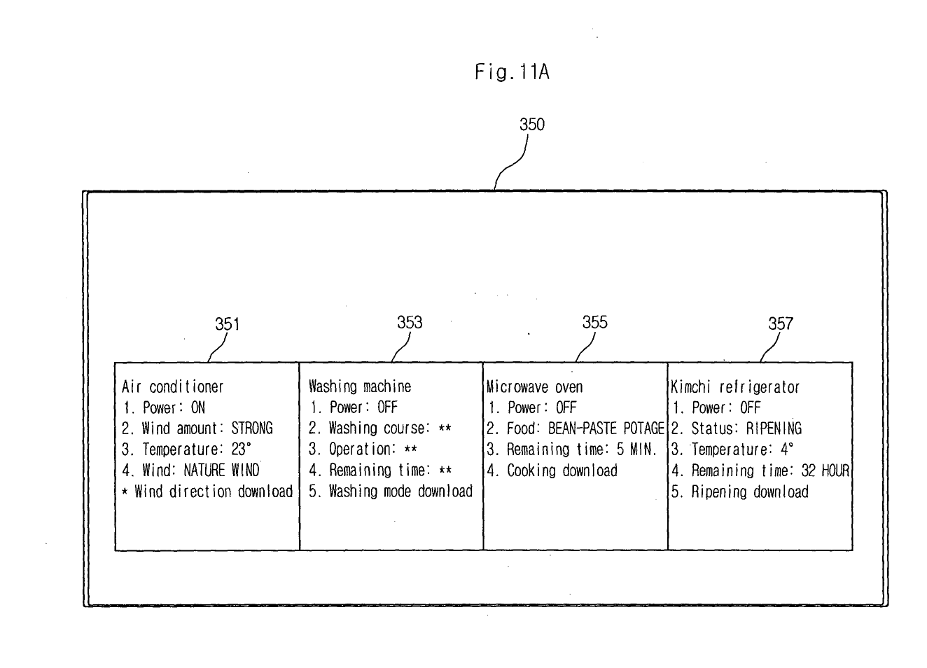

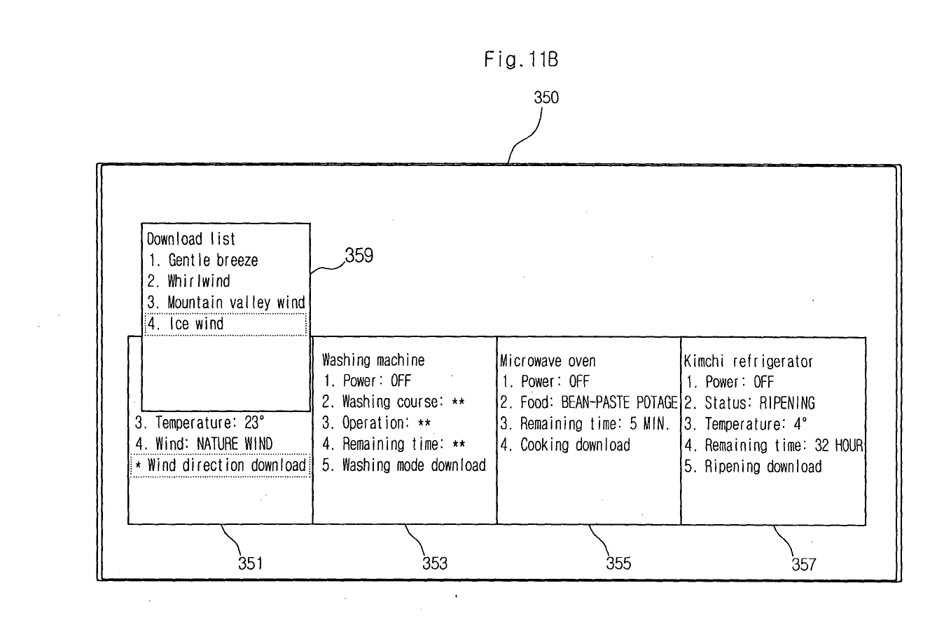

Referring to FIG. 9, if the user selects the control menu list using a remote controller that interfaces with the television set, step S455, the user request is transmitted to the menu manager, and the control menu list stored in the menu manager is transmitted to the television set and displayed on an OSD, step S457. As shown in FIG. 11A, the control menu lists 351 to 357 are displayed on the control menu screen 350. The respective control menu lists 351 to 357 include a plurality of control menu items. Here, a wind direction download item of the air conditioner, a washing mode download item of the washing machine, a cooking download item of the microwave oven and a ripening download item of the kimchi refrigerator are the download control menu items for downloading the control programs.

If the user selects the download control menu item, step S459, lists of the selected download control menu item are displayed, step S461. As shown in FIG. 11B, if the user selects the wind direction download item of the air conditioner, a corresponding list 359 is displayed. The list 359 can include a gentle breeze, a whirlwind, a mountain valley wind, an ice wind, etc.

At this point, if the user selects one of lists of the download control menu item, step S463, the control program corresponding to the selected control menu is downloaded from the server, step S465. The corresponding control programs can be continuously downloaded by additionally selecting the lists of the download control menu items.

On the contrary, if the user wants to download all control programs corresponding to the lists of the download control menu items at the same time, the user can select an auto mode, step S467. If the user selects the auto mode, the television set is connected to the server and downloads all control programs corresponding to the lists of the download control menu items, step S469.

Meanwhile, when the download operation is completed, step S471, the television set transmits all downloaded control menus to the menu manager, and the menu manager registers the downloaded control menus as new control menu items according to the equipments, step S473.

Additionally, the television set ascertains whether or not control programs for other equipments exist among the downloaded control programs, step S475. If the control programs for other equipments do not exist, the downloaded control programs are stored in the television set, step S477.

If the control programs for other equipments exist, the control programs are provided to corresponding equipments and stored therein, step S479.

In the above description, the method by which the user personally downloads the control programs for the equipments was described.

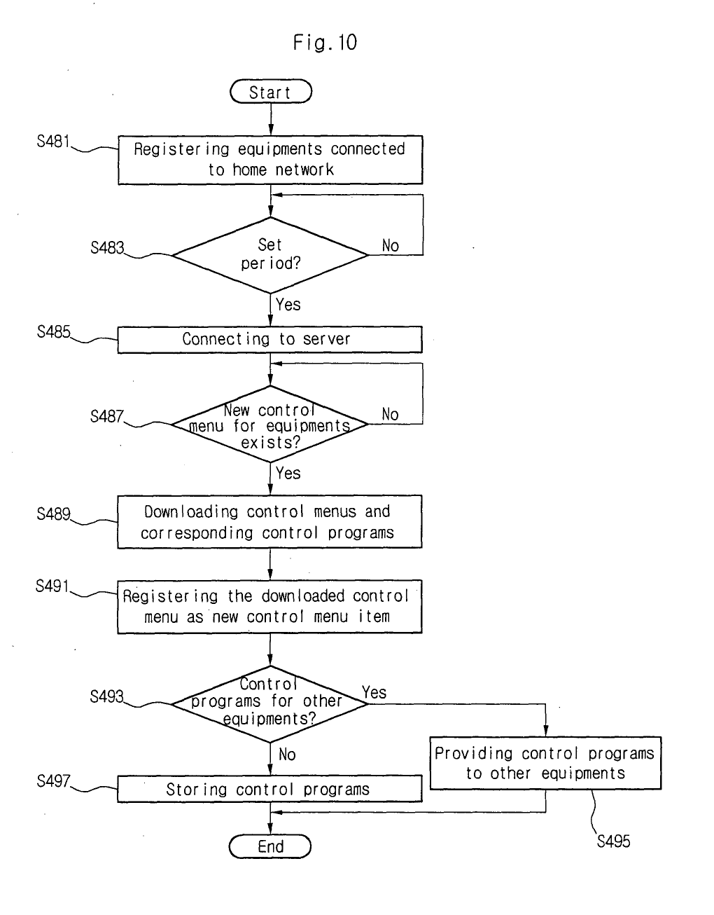

However, according to another embodiment of the present invention, the equipments themselves can download corresponding control programs without any involvement of the user, which will be described with reference to FIG. 10.

FIG. 10 is a flowchart showing a home network control method according to the present invention, in which the equipments themselves control the home network in the home network apparatus.

Referring to FIG. 10, first, the equipments connected to the home network are registered, step S481. Since this process has already been described, repetitive description will be omitted.

The television set checks a set period, step S483 and is connected to the server using the Internet if such set period has been reached, step S485.

Then, the television set ascertains whether or not new control menus for the equipments exist in the server, step S487. If the new control menus exist, the control menus for the equipments and corresponding control programs are downloaded, step S489.

The television set transmits the downloaded control menus to the menu manager, and the menu manager registers the downloaded control menus as new control menu items for the equipments, step S491. It is then determined whether or not control programs for other equipments exist among the downloaded control programs, step S493. If the control programs for other equipments do exist, the corresponding control programs are provided to other equipments and stored into the corresponding equipments, step S495. Conversely, if the control programs for other equipments do not exist, the downloaded control programs are installed in the television set, step S497.

Although the television set is described as an example in the above, it is noted that any equipments connected to the home network can also perform the home network control methods of the present invention.

Thus, according to the present invention, one equipment can download corresponding control programs. At this point, the user can download the control program from the server or the equipments themselves can download the control programs.

According to the present invention, one equipment can download control programs for other equipments as well as its own control program of course, in this case, the user or the corresponding equipments themselves can download the control programs. At this point, the respective equipments should share the control menu lists, and these control menu lists can be separately managed by the menu manager. Additionally, the equipments must have the ability to check whether the control programs are the equipment's own control program or other equipments' control programs.

As described above, in the method and system for controlling the home network according to the present invention, by periodically downloading the control programs for the equipments and controlling the corresponding equipments, the home network can be controlled more conveniently, thereby improving the performance of the home network remarkably.

Further, since one equipment can download the control programs for other equipments and provide them to corresponding equipments, the user's convenience is maximally improved without regard to user location.

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A method for controlling a home network, comprising the steps of:
ascertaining whether or not a new control menu exists by using the Internet;
if the new control menu exists, downloading the new control menu and adding the downloaded new control menu to an old control menu list; and
downloading corresponding control programs using the added new control menu.

2. The method claimed as claim 1, wherein if the new control menu is not contained in the old control menu list, the new control menu is considered as a new menu.

3. The method claimed as claim 1, wherein if the new control menu is an upgraded version, the new control menu is considered as a new menu even when the new control menu is contained in the old control menu list.

4. The method claimed as claim 1, wherein the control program is downloaded when a user selects the added new control menu.

5. The method claimed as claim 1, wherein the control program is downloaded when a user selects an auto mode.

6. The method as claimed as claim 1, wherein the downloaded control program is stored.

7. A method for controlling a home network, comprising the steps of:
ascertaining whether or not a new control menu exists by using the Internet; and
if the new control menu exists, downloading the new control menu and a corresponding control program.

8. The method claimed as claim 7, wherein if the new control menu is not contained in the old control menu list, the new control menu is considered as a new menu.

9. The method claimed as claim 7, wherein if the new control menu is an upgraded version, the new control menu is considered as a new menu even when the new control menu is contained in the old control menu list.

10. A method for controlling a home network, comprising the steps of:
a) ascertaining whether or not new control menus for equipments exist by using the Internet;
b) if the new control menus for the equipments exist, downloading the new control menus and adding the downloaded new control menus to old control menu lists according to the equipments;
c) downloading corresponding programs using the added new control menus; and
d) providing the downloaded new control menus to the corresponding equipments.

11. The method claimed as claim 10, wherein the respective equipments carry out the steps a) to d).

12. The method claimed as claim 10, wherein the old control menu lists are shared between the respective equipments.

13. The method claimed as claim 10, wherein the control programs that are not provided to the respective equipments are stored into the equipments that carry out the steps a) to d).

14. A method for controlling a home network, comprising the steps of:
a) ascertaining whether or not new control menus for equipments exist by using the Internet;
b) if the new control menus for the equipments exist, downloading the new control menus and corresponding control programs; and
c) providing the downloaded control programs to the corresponding equipments.

15. The method claimed as claim 14, wherein the respective equipments carry out the steps a) to c).

16. The method claimed as claim 14, wherein the old control menu lists are shared between the respective equipments.

17. The method claimed as claim 14, wherein the control programs that are not provided to the respective equipments are stored into the equipments that carry out the steps a) to c).

18. A system for controlling a home network, comprising:
means for ascertaining whether or not a new control menu exists by using the Internet;
means for downloading the new control menu and adding the downloaded new control menu to an old control menu list, in case the new control menu exists; and
means for downloading corresponding control programs using the added new control menu.

19. A system for controlling a home network, comprising:
means for ascertaining whether or not a new control menu exists by using the Internet; and
means for downloading the new control menu and a corresponding control program, in case the new control menu exists.

20. A system for controlling a home network, comprising:
first means for ascertaining whether or not new control menus for equipments exist by using the Internet;
second means for downloading the new control menus and adding the downloaded new control menus to old control menu lists according to the equipments, in case the new control menus for the equipments exist,;
third means for downloading corresponding programs using the added new control menus; and
fourth means for providing the downloaded new control menus to the corresponding equipments.

21. The system claimed as claim 20, wherein the respective equipments comprises the first means to the fourth means.

22. The system claimed as claim 20, wherein the old control menu lists are shared between the respective equipments.

23. A system for controlling a home network, comprising:
first means for ascertaining whether or not new control menus for equipments exist by using the Internet;
second means for downloading the new control menus and corresponding control programs, in case the new control menus for the equipments exist; and
third means for providing the downloaded control programs to the corresponding equipments.

24. The system claimed as claim 23, wherein the respective equipments comprises the first means to the fourth means.

25. The system claimed as claim 23, wherein the old control menu lists are shared between the respective equipments.

26. A home network apparatus including the Internet network and a home network, the home network being provided with information via the Internet network, wherein the home network includes:
a power line for supplying communication signals, control signals and power source; and
a plurality of equipments connected to the power line and having the Internet function and an on-screen function, the equipments downloading control menus and corresponding control programs from the Internet network by using the Internet function, control menu lists with the control menus being displayed on screen by using the on-screen function,
whereby the plurality of equipments download only their own corresponding control programs through the Internet network.

27. A home network apparatus, the home network apparatus including the Internet network and a home network receiving information through the Internet network, the home network apparatus comprising:
a power line for supplying communication signals, control signals and power source;
a plurality of equipments connected to the power line and having the Internet function and an on-screen function, the equipments downloading control menus and corresponding control programs from the Internet network by using the Internet function, control menu lists with the control menus being displayed on screen by using the on-screen function; and
a menu manager for storing the control menu lists, registering the downloaded control menu as a new control menu item into the control menu list, and providing the control menu lists to the respective equipments by request,
wherein the plurality of equipments download through the Internet network the control programs for other equipments as well as their own control programs.

28. The home network apparatus claimed in claim 27, wherein the menu manager manages the control menu lists for the equipments through a sharing of the menu lists.
